(19) United States
(12) Patent Application Publication
(10) Pub. No.: US 2019/0297700 A1
(43) Pub. Date: Sep. 26, 2019

(54) DEVICE, SYSTEM AND METHOD FOR CONTROLLING OPERATION OF LIGHTING UNITS

(71) Applicant: TAOLIGHT Company Limited, North Point (HK)

(72) Inventor: Jean-Philippe GAL, North Point (HK)

(21) Appl. No.: 15/554,678

(22) PCT Filed: Feb. 23, 2017
(86) PCT No.: PCT/CN2017/074602

§ 371 Date: Aug. 30, 2017

(30) Foreign Application Priority Data
Dec. 20, 2016 (HK) 16114488.2

(51) Int. Cl. H05B 33/08; H05B 37/02

(52) U.S. Cl. CPC H05B 33/0866; H05B 33/0854; H05B 37/0272

(57) ABSTRACT

A system for controlling operation of a lighting unit including a lighting unit having a communication module and an illumination module for producing an output lighting emission within a target environment. Also included is a data store module for storing at least one predefined lighting condition data indicative of a predefined lighting condition. A mobile electronic device is also included with a communication module for communicating with the communication module of the lighting unit via a communication link; a sensor module for sensing lighting data indicative of a lighting condition within the target environment; and a processor module configured for comparing the sensed data indicative of the lighting condition within the target environment against the at least one predefined lighting condition data indicative of the predefined lighting condition. A controller module is also included and configured for communicating with the lighting unit via the communication link.

### TECHNICAL FIELD

The present invention relates to devices, systems and methods for controlling operation of lighting units such as networked LED lamps, luminaires and the like.

### BACKGROUND OF THE INVENTION

Modern day lighting devices such as lamps, luminaires and the like may be controllable by a user to output a desired lighting characteristic. For instance, the user may be able to manipulate a control interface to adjust the colour temperature, brightness, dimming behavior and other light emission characteristics to achieve the output desired lighting characteristic. One problem with the use of such lighting devices is that a user may not know how to optimally adjust the operational settings (e.g. colour, brightness, dimming, etc.) of the lighting device to achieve an output lighting characteristic that is suitable and effective in meeting the user's specific lighting requirements. Another problem is that even when the user has suitably adjusted the operational settings of the lighting unit, it may be difficult for the user to quickly and easily remember how to replicate the same operational settings on the same lighting device or a different lighting device again in future. Whilst certain smart lighting systems have sought to provide different lighting modes (e.g. warm white, cool white, party mode etc) such lighting modes are presets and do not take into account the bespoke nature of different user environments and factors which contribute to the overall lighting conditions within the different user environments. Accordingly, there is a perceived need to improve the way users can control operation of lighting devices in view of such problems.

### SUMMARY OF THE INVENTION

The present invention seeks to alleviate at least one of the above-described problems.

The present invention may involve several broad forms. Embodiments of the present invention may include one or any combination of the different broad forms herein described.

In a first broad form, the present invention provides a system for controlling operation of a lighting unit, the system including:

a lighting unit having a communication module and an illumination module for producing an output lighting emission within a target environment;

a data store module for storing at least one predefined lighting condition data indicative of a predefined lighting condition; and

a mobile electronic device comprising:
a communication module for communicating with the communication module of the lighting unit via a communication link;
a sensor module for sensing lighting data indicative of a lighting condition within the target environment;
a processor module configured for comparing the sensed data indicative of the lighting condition within the target environment against the at least one predefined lighting condition data indicative of the predefined lighting condition; and
a controller module, whereby, responsive to the comparison, the controller module is configured for communicating with the lighting unit via the communication link to controllably adjust the output lighting emission of the illumination module within the target environment until, based on further comparison by the processor module, the sensed lighting data indicative of the lighting condition within the target environment is determined by the processor module to be indicative of the predefined lighting condition data by reference to a predefined threshold criteria.

Preferably, the mobile electronic device may include at least one of a smartphone, a tablet and a portable computer.

Additionally and/or alternatively, the present invention may include a further processor module configured for partially or entirely comparing the data indicative of the sensed lighting condition within the environment against the at least one predefined lighting condition data, said further processor module including at least one of a processor module of the lighting unit, a server-side processor module and a cloud-based processor module communicably connected with the mobile electronic device.

Additionally and/or alternatively, the present invention may include a further controller module configured for partially or entirely controllably adjusting the output lighting emission of the illumination module within the target environment until, based on the further comparison by the processor module, the sensed lighting condition within the target environment is determined by the processor module or a further processor module to be indicative of the predefined lighting condition by reference to the predefined threshold criteria, said further processor module including at least one of a controller module of the lighting unit, a server-side controller module and a cloud-based controller module communicably connected with the mobile electronic device.

Additionally and/or alternatively, the data store module may include at least one of a data store module of the mobile electronic device, a data store module of the lighting unit, a server-side data store module, and a cloud-based data store module communicably connected with the mobile electronic device.

Preferably, the sensor module may include at least one of a CMOS-type sensor, a CCD-type sensor, a LiveMOS type sensor, an ambient light sensor, a photoelectric sensor, a thermal sensor, a temperature sensor, a gyroscope, a magnetometer, proximity sensor, and a GPS sensor.

Preferably, the communication module of the lighting unit may include a wireless protocol communication module.

Preferably, the predefined lighting condition data indicative of the predefined lighting condition includes data indicative of at least one of a brightness condition, a colour temperature condition, a dimming condition, a white light condition, and a warm light condition, a colour rendition index condition, and a saturation condition.

Preferably, the data store may be configured for storing a plurality of predefined lighting condition datas each being indicative of one of a plurality of corresponding predefined lighting conditions.

Preferably, each of said plurality of predefined lighting conditions may be associated with one of a plurality of corresponding target environment types.

Preferably, the mobile electronic device may include:

an output module configured for electronically displaying indicia indicative of the plurality of target environment types; and

an input module configured for receiving as an input, a selection associated with an indicia indicative of one of the plurality of target environment types, whereby responsive to the selection, the processor module is configured for comparing the sensed data indicative of the lighting condition within the target environment against the predefined lighting condition data indicative of the predefined lighting condition associated with the corresponding target environment type selected via the input module, and, whereby, responsive to the comparison, the controller module is configured for communicating with the lighting unit via the communication link to controllably adjust the output lighting emission of the illumination module within the target environment until, based on further comparison by the processor module, the sensed lighting data indicative of the lighting condition within the target environment is determined by the processor module to be indicative of the predefined lighting condition data by reference to a predefined threshold criteria.

Preferably, the data store module may be configured for storing a computer program that is operable by the processor module to configure the mobile electronic device for operation as the output module and the input module of this broad form of the present invention.

Preferably, the present invention may include a touch-sensitive electronic display module configured for operating as at least one of the output module and the input module.

In a further broad form, the present invention provides a mobile electronic device for controlling operation of a lighting unit having a communication module and an illumination module for producing an output lighting emission within a target environment, the device including:
a communication module for communicating with the communication module of the lighting unit via a communication link;
a sensor module for sensing lighting data indicative of a lighting condition within the target environment;
a processor module configured for comparing the sensed data indicative of the lighting condition within the target environment against at least one predefined lighting condition data indicative of the predefined lighting condition stored in a data store module; and
a controller module, whereby, responsive to the comparison, the controller module is configured for communicating with the lighting unit via the communication link to controllably adjust the output lighting emission of the illumination module within the target environment until, based on further comparison by the processor module, the sensed lighting data indicative of the lighting condition within the target environment is determined by the processor module to be indicative of the predefined lighting condition data by reference to a predefined threshold criteria.

Preferably, the present invention includes at least one of a smartphone, a tablet and a portable computer.

Additionally and/or alternatively, the present invention may include a further processor module configured for partially or entirely comparing the data indicative of the sensed lighting condition within the environment against the at least one predefined lighting condition data, said further processor module including at least one of a processor module of the lighting unit, a server-side processor module and a cloud-based processor module communicably connected with the device.

Additionally and/or alternatively, the present invention may include a further controller module configured for partially or entirely controllably adjusting the output lighting emission of the illumination module within the target environment until, based on the further comparison by the processor module, the sensed lighting condition within the target environment is determined by the processor module or a further processor module to be indicative of the predefined lighting condition by reference to the predefined threshold criteria, said further processor module including at least one of a controller module of the lighting unit, a server-side controller module and a cloud-based controller module communicably connected with the device.

Additionally and/or alternatively, the data store module may include at least one of a data store module of the device, a data store module of the lighting unit, a server-side data store module, and a cloud-based data store module communicably connected with the device.

Preferably, the sensor module may include at least one of a CMOS-type sensor, a CCD-type sensor, a LiveMOS type sensor, an ambient light sensor, a photoelectric sensor, a thermal sensor, a temperature sensor, a gyroscope, a magnetometer, proximity sensor, and a GPS sensor.

Preferably, the communication module of the lighting unit may include a wireless protocol communication module.

Preferably, the predefined lighting condition data indicative of the predefined lighting condition may include data indicative of at least one of a brightness condition, a colour temperature condition, a dimming condition, a white light condition, and a warm light condition, a colour rendition index condition, and a saturation condition.

Preferably, the data store may be configured for storing a plurality of predefined lighting condition datas each being indicative of one of a plurality of corresponding predefined lighting conditions.

Preferably, each of said plurality of predefined lighting conditions may be associated with one of a plurality of corresponding target environment types.

Preferably, the device may include:

an output module configured for electronically displaying indicia indicative of the plurality of target environment types; and

an input module configured for receiving as an input, a selection associated with an indicia indicative of one of the plurality of target environment types, whereby responsive to the selection, the processor module is configured for comparing the sensed data indicative of the lighting condition within the target environment against the predefined lighting condition data indicative of the predefined lighting condition associated with the corresponding target environment type selected via the input module, and, whereby, responsive to the comparison, the controller module is configured for communicating with the lighting unit via the communication link to controllably adjust the output lighting emission of the illumination module within the target environment until, based on further comparison by the processor module, the sensed lighting data indicative of the lighting condition within the target environment is determined by the processor module to be indicative of the predefined lighting condition data by reference to a predefined threshold criteria.

Preferably, the data store module may be configured for storing a computer program that is operable by the processor module to configure the device for operation as the output module and as the input module in accordance with this broad form of the present invention.

Preferably, the present invention may include a touch-sensitive electronic display module configured for operating as at least one of the output module and the input module.

In a further broad form, the present invention provides a method for controlling operation of a lighting unit having a communication module and an illumination module for producing an output lighting emission within a target environment, the method including steps of:

(i) providing a data store module for storing at least one predefined lighting condition data indicative of a predefined lighting condition; and

(ii) providing a mobile electronic device comprising:
a communication module for communicating with the communication module of the lighting unit via a communication link;
   a sensor module for sensing lighting data indicative of a lighting condition within the target environment;
   a processor module configured for comparing the sensed data indicative of the lighting condition within the target environment against the at least one predefined lighting condition data indicative of the predefined lighting condition; and
   a controller module, whereby, responsive to the comparison, the controller module is configured for communicating with the lighting unit via the communication link to controllably adjust the output lighting emission of the illumination module within the target environment until, based on further comparison by the processor module, the sensed lighting data indicative of the lighting condition within the target environment is determined by the processor module to be indicative of the predefined lighting condition data by reference to a predefined threshold criteria.

Preferably, the mobile electronic device may include at least one of a smartphone, a tablet and a portable computer.

Additionally and/or alternatively, the present invention may include a further processor module configured for partially or entirely comparing the data indicative of the sensed lighting condition within the environment against the at least one predefined lighting condition data, said further processor module including at least one of a processor module of the lighting unit, a server-side processor module and a cloud-based processor module communicably connected with the mobile electronic device.

Additionally and/or alternatively, the present invention may including a further controller module configured for partially or entirely controllably adjusting the output lighting emission of the illumination module within the target environment until, based on the further comparison by the processor module, the sensed lighting condition within the target environment is determined by the processor module or a further processor module to be indicative of the predefined lighting condition by reference to the predefined threshold criteria, said further processor module including at least one of a controller module of the lighting unit, a server-side controller module and a cloud-based controller module communicably connected with the mobile electronic device.

Additionally and/or alternatively, the data store module may include at least one of a data store module of the mobile electronic device, a data store module of the lighting unit, a server-side data store module, and a cloud-based data store module communicably connected with the mobile electronic device.

Preferably, the sensor module may include at least one of a CMOS-type sensor, a CCD-type sensor, a LiveMOS type sensor, an ambient light sensor, a photoelectric sensor, a thermal sensor, a temperature sensor, a gyroscope, a magnetometer, proximity sensor, and a GPS sensor.

Preferably, the communication module of the lighting unit may include a wireless protocol communication module.

Preferably, the predefined lighting condition data indicative of the predefined lighting condition may include data indicative of at least one of a brightness condition, a colour temperature condition, a dimming condition, a white light condition, and a warm light condition, a colour rendition index condition, and a saturation condition.

Preferably, the data store module may be configured for storing a plurality of predefined lighting condition datas each being indicative of one of a plurality of corresponding predefined lighting conditions.

Preferably, each of said plurality of predefined lighting conditions may be associated with one of a plurality of corresponding target environment types.

Preferably, the mobile electronic device may include:

an output module configured for electronically displaying indicia indicative of the plurality of target environment types; and

an input module configured for receiving as an input, a selection associated with an indicia indicative of one of the plurality of target environment types, whereby responsive to the selection, the processor module is configured for comparing the sensed data indicative of the lighting condition within the target environment against the predefined lighting condition data indicative of the predefined lighting condition associated with the corresponding target environment type selected via the input module, and, whereby, responsive to the comparison, the controller module is configured for communicating with the lighting unit via the communication link to controllably adjust the output lighting emission of the illumination module within the target environment until, based on further comparison by the processor module, the sensed lighting data indicative of the lighting condition within the target environment is determined by the processor module to be indicative of the predefined lighting condition data by reference to a predefined threshold criteria.

Preferably, the data store module may be configured for storing a computer program that is operable by the processor module to configure the mobile electronic device for operation as the output module and the input module in accordance with this broad form of the present invention.

Preferably, the present invention may include a touch-sensitive electronic display module configured for operating as at least one of the output module and the input module.

It will be apparent that the broad forms of the present invention may assist in providing a relatively fast and easy way in which a user may utilise a mobile electronic device such as a smartphone within a specific type of target environment (e.g. sofa, bed top, dining table, bathroom etc) to automatically control the output lighting emissions of a lighting unit into the target environment until the lighting conditions within the target environment are indicative of a predefined lighting condition. This obviates the need for the user having to remember and manually apply certain lighting settings to the lighting unit to achieve a desirable lighting condition within the target environment.

### BRIEF DESCRIPTION OF THE DRAWINGS

The present invention will become more fully understood from the following detailed description of a preferred but non-limiting embodiment thereof, described in connection with the accompanying drawings, wherein:

FIG. 1 shows a flow-diagram of method steps in accordance with one embodiment of the present invention;

FIG. 2 shows a functional block diagram of a lighting unit used in accordance with an embodiment of the present invention;

FIG. 3 shows a functional block diagram of a mobile electronic device serving as the electronic display module and user input interface for controlling the lighting unit in accordance with an embodiment of the present invention; and

FIG. 4 depicts an example layout of a lighting control system in accordance with an embodiment of the present invention.

### DETAILED DESCRIPTION OF THE PREFERRED EMBODIMENTS

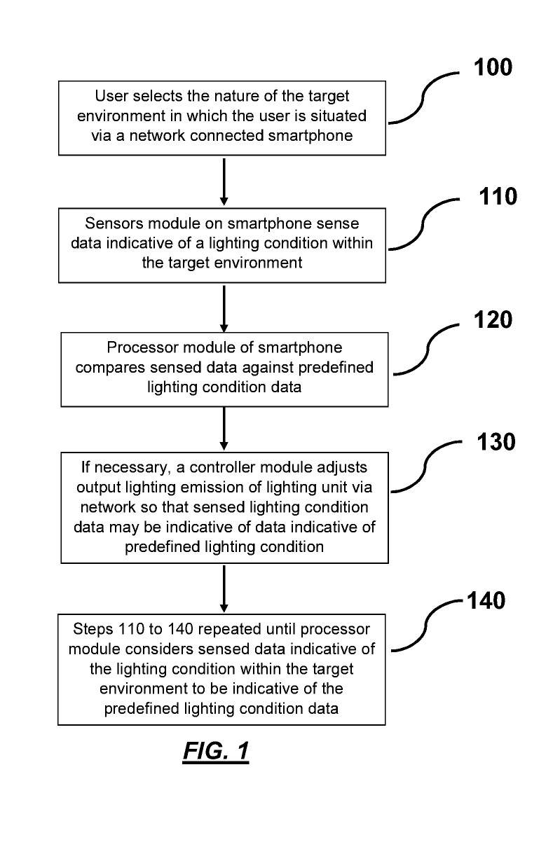

Preferred embodiments of the present invention will now be described with reference to the drawings FIGS. 1 to 4.

Referring to FIG. 4, a system is shown whereby a user may relatively quickly and easily use a smartphone to automatically tune a networked lighting unit (200) to output a light emission (600) within a target environment (400) which results in a sensed lighting condition within the target environment (400) being indicative of a predefined lighting condition associated with the target environment (400). In the following description, embodiments of the present invention will be described with reference to operation of a single lighting unit (200) for ease of illustration of operation of embodiments of the present invention. However, it would be appreciated that multiple lighting units may typically be connected to the network that are controllable simultaneously and in a similar manner as will be described herein.

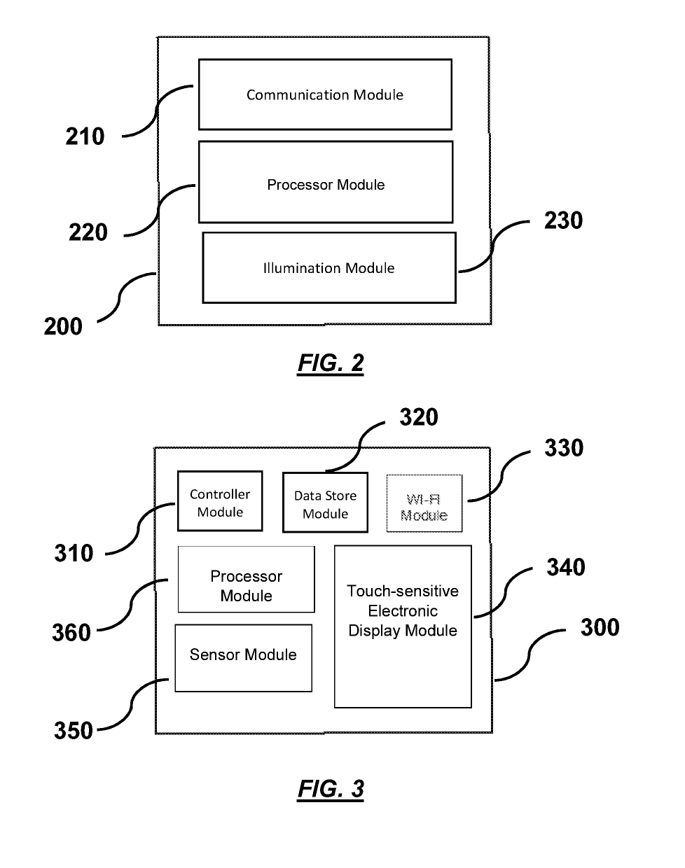

Referring to FIG. 2, a functional block diagram of an exemplary networked lighting unit (200) is shown which comprises an illumination module (230) for outputting lighting emissions (600) therefrom, a Wi-Fi communication module (210) for wireless protocol communication with other networked devices such as the smartphone (300) via the Wi-Fi router (500), and a processor module (220) for processing basic functions of the lighting unit (200) as well as for operating the illumination module (230). The illumination module (230) may comprise of any suitable type of lighting technology however in this embodiment comprises an LED lighting module configured to output a range of lighting characteristics (600) including for instance varying colour temperatures, hues, brightness characteristics, colour rendition index characteristics, cool white and warm white characteristics, and saturation characteristics in response control instructions received from the smartphone (300) during auto-tuning. The networked lighting unit (200) also includes a unique identifier such as a MAC address that is automatically readable by the smartphone (300) so as to identity the lighting unit (200) including for instance a make and model of the smartphone (200).

The smartphone (200) used as the controller module (300) in this embodiment includes a Wi-Fi communication module (330) via which it can communicate with the corresponding communication module (210) of the lighting unit (200) via the WI-FI router (500).

In this embodiment, at least some of the functional components of the system are integrally embodied in the smartphone (300) which serves as the primary controller module (300). It would be appreciated that in alternate embodiments, some of the functional components of the system may be embodied in a relatively more distributed architecture whereby certain control and processing functions may be performed partially or entirely externally of the smartphone (300), for instance via a cloud or server-side type processor module operably connected to the smartphone via a communication network, such as the Internet or a home or office network.

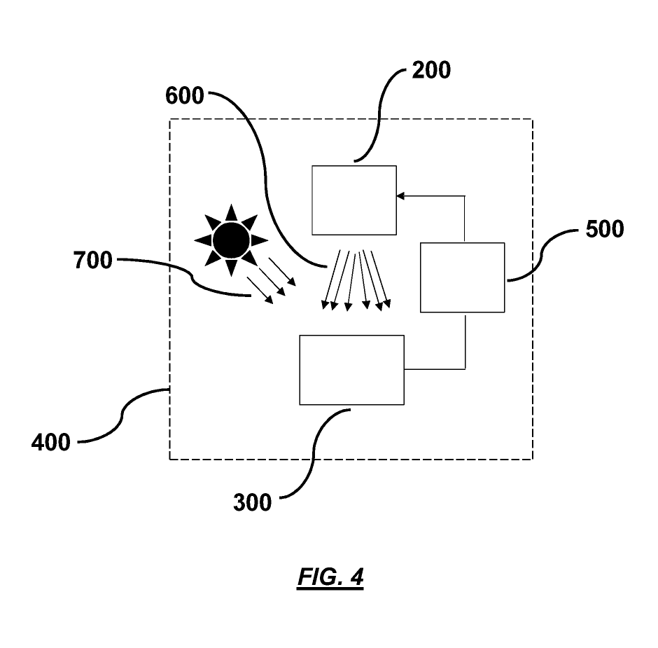

Turning now to FIG. 3, the smartphone (300) includes a sensor module (350) comprising an array of sensor devices such as a number of CMOS-type sensor, a CCD-type sensor, a LiveMOS type sensor, an ambient light sensor, which may form part of the functional circuitry of a digital camera module of the smartphone (300). Other sensor devices may include a photoelectric sensor, a thermal sensor or a temperature sensor. Such sensors may suitably for sensing various characteristics of the lighting condition within the target environment which may include for instance, a brightness characteristic, a colour temperature characteristic, a white light characteristic, a warm light characteristic, a colour rendition index characteristic, and a dimming characteristic within the target environment. These sensed characteristics of the lighting condition within the target environment (400) will also be affected not only by the output light emission (600) of the lighting unit (200) but will also be affected by the ambient light source (700) emission as well.

The sensors module (350) includes other sensors devices of the smartphone such as a gyroscope, a magnetometer, proximity sensor, and a GPS sensor which may be useful in sensing secondary data useful, for instance, in determining a relative position and/or orientation of the one or more lighting units or ambient light sources (700) relative to the target environment. Such secondary sensed data may also be useful in calculating an adjustment to the output lighting emission (600) of the lighting unit (200) to provide a resulting lighting condition within the target environment (400) which is indicative of the predefined lighting condition associated with the target environment (400) including for instance, a brightness characteristic, a colour temperature characteristic, a white light characteristic, a warm light characteristic, a colour rendition index characteristic, a saturation characteristic and a dimming characteristic of the lighting conditions within the target environment (400).

The smartphone (300) also includes a data store module (320) operably connected with the sensors module (350), processor module (360) and controller module (310). The data store (320) module of the smartphone (300) is configured for storing a library of predefined lighting condition datas associated with each of the different types of target environments (400) represented by the array of interactive icons displayed on the graphical user-interface of the smartphone (300). The data store (320) may also be utilised for storing sensed data that is sensed by the various sensor devices in the sensors module (350) of the smartphone (300). Any or all of this data may be configured for synchronized storage upon a cloud or server-side based data store that is communicably connected with the smartphone (300).

The smartphone (300) includes a touch-sensitive electronic display module (340) which functions as both an output display module and also as the graphical user interface module for inputting user commands to control operation of the system. It is of course possible in alternate embodiments for the input module to be a separate input device such as a physical keypad, touchpad or mouse type device interface. A software application module is downloadable into the data store (320) of the smartphone (300) from an online computer server via the communication network and is executable by the processor module (360) of the smartphone (300) to function as the input graphical user-interface. The software application module is further configured to allow operable connection of the smartphone (300) with the lighting unit (200) via the respective communication modules, to recognise the lighting unit (200) by its unique identifier, and to automatically control operation of the lighting unit (200) output emission settings via the graphical user interface of the smartphone (300). In alternate embodiments, the various user-interactive control provided by the software application module may be implemented by embedded software disposed in the hardware itself or any other suitable hardware technology.

The interactive graphic user interface (340) displays the selectable interactive icons representing the different types of target environments. Each of the interactive icons displayed on the graphical user interface (340) are associated with predefined lighting condition datas which are indicative of predefined optimal lighting conditions for each target environment (400). The target environments may include for instance a bed-time reading environment, a breakfast time environment, a dinner table environment, a bathroom environment etc. By way of example, typically a good reading light condition may comprise a bright white light having a particular colour temperature, whilst an optimal lighting condition for food will require neutral white light with good colour rendering index. The interactive graphical user interface (340) may also allow a user to define his/her own bespoke target environments and lighting conditions associated with such target environments which may then be saved and displayed for use.

In this embodiment, once the user has selected a suitable icon on the graphical user interface (340) (this step being represented at (100) in FIG. 1.), responsive to the input via the graphical user interface (340), the sensors module (350) is configured for activation so that the array of sensor devices commence sensing of data within the target environment (400) (this step being represented by block (110) in FIG. 1). The sensed data indicative of the lighting conditions within the target environment (400) (which result from both lighting unit emissions (600) as well as ambient light sources (700)), are then compared against data indicative of the predefined lighting condition associated with the target environment as stored in the library on the smartphone (300) by the processor module (360) with reference to a predefined threshold criteria (this step being represented by block (120) of FIG. 1). Any number of suitable computer algorithms may be used for the purposes of performing the comparison of the data and based on an applicable threshold criteria employed by the processor module (360). It would be understood that the comparison of data is a comparison of not necessarily the form of the data but more importantly, of the substance and meaning represented by the respective data. Responsive to the comparison being made, if the sensed data is determined to be indicative of the data indicative of the predefined lighting condition, then the controller module (310) does not effect any adjustment to the lighting output emission (600) of the lighting unit (200) and causes the processor module (360) to terminate further processing. However, if the sensed data is not determined to be indicative of the data indicative of the predefined lighting condition, then a controller module (310) of the smartphone (300) operably connected with the processor module (360) automatically communicates with the lighting unit (200) via respective communication modules and via the Wi-Fi router (500), instructing the lighting unit (200) to suitably adjust one or more output lighting settings (this step being represented by block (130) in FIG. 1). This processor module (360) may be required to send a series of incremental control instructions to the networked lighting unit (200) to adjust one or more output lighting characteristics, before the one or more lighting output settings are adjusted to an appropriate level until the sensed data is indicative of the data indicative of the predefined lighting condition (this step being represented by block (140) in FIG. 1). In this embodiment, the smartphone (300) is aware of the identity of the relevant lighting unit (200) which is responsible for emitting lighting emissions into the target environment (400) as the software is configured to predefine and recognise the proximity of different lighting units (200) connected to the network in relation to the various target environments within the premises. In certain embodiments, where there may be multiple lighting units in proximity of the target environment and which may impact upon the sensed lighting condition within the target environment, the smartphone may be configured for operation whereby it may switch on each of the lighting unit one at a time (or physical clusters of lighting units one at a time, or types of lighting units one at a time) in order to sense the impact of each of the different lighting units upon the target environment. Upon sensing the impact of each of the lighting units (or groups of lighting units) individually, the smartphone may then be able to control the one or more lighting units ina a more efficient manner. For instance, if only one of the networked lighting units is primarily responsible for affecting the lighting condition in the target environment, then the smartphone may be configured to adjust only with that one particular lighting unit. Alternatively, if all of the lighting units have substantially the same effect upon the lighting condition in the target environment, then the smartphone may be able to multicast the same control message to all of these lighting units rather than communication separate control messages to each of the individual lighting units.

It will be appreciated that embodiments of the present invention may assist in providing at least one advantage over existing technologies including that a system and method is provided by which a user may simply place the smartphone (300) on a dinner table, bed-top on any other desired environment, and then allow the smartphone (300) to automatically adjust (i.e. “auto tune”) the lighting unit (200) or group of lighting units in proximity to the target environment (400) until a desired predefined lighting condition for the target environment (400) has been achieved in real-time and taking into account ambient light sources and other contributing factors specific to the target environment (400). This convenient as it utilises the existing array of sensor devices in the mobile smartphone device to provide the sensing capability and network communication capability with the networked lighting device. Embodiments of the present invention may be advantageous in a range of day-to-day situations including for instance alleviating eye strain and eye damage resulting from exposure to poor lighting conditions and the inability to flexibly adjust such lighting conditions. Suitable reading lighting may be provided for a user quickly, easily and automatically by operation of the smartphone or other mobile electronic device.

Those skilled in the art will appreciate that the invention described herein is susceptible to variations and modifications other than those specifically described without departing from the scope of the invention. All such variations and modification which become apparent to persons skilled in the art, should be considered to fall within the spirit and scope of the invention as broadly hereinbefore described. It is to be understood that the invention includes all such variations and modifications. The invention also includes all of the steps and features, referred or indicated in the specification, individually or collectively, and any and all combinations of any two or more of said steps or features.

The reference to any prior art in this specification is not, and should not be taken as, an acknowledgment or any form of suggestion that that prior art forms part of the common general knowledge.

What is claimed is:

1. A system for controlling operation of a lighting unit, the system including:
a lighting unit having a communication module and an illumination module for producing an output lighting emission within a target environment;
a data store module for storing at least one predefined lighting condition data indicative of a predefined lighting condition; and
a mobile electronic device comprising:
a communication module for communicating with the communication module of the lighting unit via a communication link;
a sensor module for sensing lighting data indicative of a lighting condition within the target environment;
a processor module configured for comparing the sensed data indicative of the lighting condition within the target environment against the at least one predefined lighting condition data indicative of the predefined lighting condition; and
a controller module, whereby, responsive to the comparison, the controller module is configured for communicating with the lighting unit via the communication link to controllably adjust the output lighting emission of the illumination module within the target environment until, based on further comparison by the processor module, the sensed lighting data indicative of the lighting condition within the target environment is determined by the processor module to be indicative of the predefined lighting condition data by reference to a predefined threshold criteria.

2. A system as claimed in claim 1 wherein the mobile electronic device includes at least one of a smartphone, a tablet and a portable computer.

3. A system as claimed in claims 1 or 2 including a further processor module configured for partially or entirely comparing the data indicative of the sensed lighting condition within the environment against the at least one predefined lighting condition data, said further processor module including at least one of a processor module of the lighting unit, a server-side processor module and a cloud-based processor module communicably connected with the mobile electronic device.

4. A system as claimed in any one of the preceding claims including a further controller module configured for partially or entirely controllably adjusting the output lighting emission of the illumination module within the target environment until, based on the further comparison by the processor module, the sensed lighting condition within the target environment is determined by the processor module or a further processor module to be indicative of the predefined lighting condition by reference to the predefined threshold criteria, said further processor module including at least one of a controller module of the lighting unit, a server-side controller module and a cloud-based controller module communicably connected with the mobile electronic device.

5. A system as claimed in any one of the preceding claims wherein the data store module includes at least one of a data store module of the mobile electronic device, a data store module of the lighting unit, a server-side data store module and a cloud-based data store module communicably connected with the mobile electronic device.

6. A system as claimed in any one of the preceding claims wherein the sensor module includes at least one of a CMOS-type sensor, a CCD-type sensor, a LiveMOS type sensor, an ambient light sensor, a photoelectric sensor, a thermal sensor, a temperature sensor, a gyroscope, a magnetometer, proximity sensor, and a GPS sensor.

7. A system as claimed in any one of the preceding claims wherein the communication module of the lighting unit includes a wireless protocol communication module.

8. A system as claimed in any one of the preceding claims wherein the predefined lighting condition data indicative of the predefined lighting condition includes data indicative of at least one of a brightness condition, a colour temperature condition, a dimming condition, a white light condition, and a warm light condition, a colour rendition index condition, and a saturation condition.

9. A system as claimed in any one of the preceding claims wherein the data store is configured for storing a plurality of predefined lighting condition datas each being indicative of one of a plurality of corresponding predefined lighting conditions.

10. A system as claimed in claim 9 wherein each of said plurality of predefined lighting conditions are associated with one of a plurality of corresponding target environment types.

11. A system as claimed in any one of the preceding claims wherein the mobile electronic device includes:
an output module configured for electronically displaying indicia indicative of the plurality of target environment types; and
an input module configured for receiving as an input, a selection associated with an indicia indicative of one of the plurality of target environment types, whereby responsive to the selection, the processor module is configured for comparing the sensed data indicative of the lighting condition within the target environment against the predefined lighting condition data indicative of the predefined lighting condition associated with the corresponding target environment type selected via the input module, and, whereby, responsive to the comparison, the controller module is configured for communicating with the lighting unit via the communication link to controllably adjust the output lighting emission of the illumination module within the target environment until, based on further comparison by the processor module, the sensed lighting data indicative of the lighting condition within the target environment is determined by the processor module to be indicative of the predefined lighting condition data by reference to a predefined threshold criteria.

12. A system as claimed in claim 11 wherein the data store module is configured for storing a computer program that is operable by the processor module to configure the mobile electronic device for operation in accordance with claim 11.

13. A system as claimed in any one of claims 11 or 12 including a touch-sensitive electronic display module configured for operating as at least one of the output module and the input module.

14. A mobile electronic device for controlling operation of a lighting unit having a communication module and an illumination module for producing an output lighting emission within a target environment, the device including:
a communication module for communicating with the communication module of the lighting unit via a communication link;
a sensor module for sensing lighting data indicative of a lighting condition within the target environment;
a processor module configured for comparing the sensed data indicative of the lighting condition within the target environment against at least one predefined lighting condition data indicative of the predefined lighting condition stored in a data store module; and
a controller module, whereby, responsive to the comparison, the controller module is configured for communicating with the lighting unit via the communication link to controllably adjust the output lighting emission of the illumination module within the target environment until, based on further comparison by the processor module, the sensed lighting data indicative of the lighting condition within the target environment is determined by the processor module to be indicative of the predefined lighting condition data by reference to a predefined threshold criteria.

15. A device as claimed in claim 14 wherein the device includes at least one of a smartphone, a tablet and a portable computer.

16. A device as claimed in any one of claims 14 or 15 including a further processor module configured for partially or entirely comparing the data indicative of the sensed lighting condition within the environment against the at least one predefined lighting condition data, said further processor module including at least one of a processor module of the lighting unit, a server-side processor module and a cloud-based processor module communicably connected with the device.

17. A device as claimed in any one of claims 14 to 16 including a further controller module configured for partially or entirely controllably adjusting the output lighting emission of the illumination module within the target environment until, based on the further comparison by the processor module, the sensed lighting condition within the target environment is determined by the processor module or a further processor module to be indicative of the predefined lighting condition by reference to the predefined threshold criteria, said further processor module including at least one of a controller module of the lighting unit, a server-side controller module and a cloud-based controller module communicably connected with the device.

18. A device as claimed in any one of claims 14 to 17 wherein the data store module includes at least one of a data store module of the device, a data store module of the lighting unit, a server-side data store, and a cloud-based data store module communicably connected with the device.

19. A device as claimed in any one of claims 14 to 18 wherein the sensor module includes at least one of a CMOS-type sensor, a CCD-type sensor, a LiveMOS type sensor, an ambient light sensor, a photoelectric sensor, a thermal sensor, a temperature sensor, a gyroscope, a magnetometer, proximity sensor, and a GPS sensor.

20. A device as claimed in any one of claims 14 to 19 wherein the communication module of the lighting unit includes a wireless protocol communication module.

21. A device as claimed in any one claims 14 to 20 wherein the predefined lighting condition data indicative of the predefined lighting condition includes data indicative of at least one of a brightness condition, a colour temperature condition, a dimming condition, a white light condition, and a warm light condition, a colour rendition index condition, and a saturation condition.

22. A device as claimed in any one of claims 14 to 21 wherein the data store is configured for storing a plurality of predefined lighting condition datas each being indicative of one of a plurality of corresponding predefined lighting conditions.

23. A device as claimed in claim 22 wherein each of said plurality of predefined lighting conditions are associated with one of a plurality of corresponding target environment types.

24. A device as claimed in any one of 14 to 23 claims wherein the device includes:
an output module configured for electronically displaying indicia indicative of the plurality of target environment types; and
an input module configured for receiving as an input, a selection associated with an indicia indicative of one of the plurality of target environment types, whereby responsive to the selection, the processor module is configured for comparing the sensed data indicative of the lighting condition within the target environment against the predefined lighting condition data indicative of the predefined lighting condition associated with the corresponding target environment type selected via the input module, and, whereby, responsive to the comparison, the controller module is configured for communicating with the lighting unit via the communication link to controllably adjust the output lighting emission of the illumination module within the target environment until, based on further comparison by the processor module, the sensed lighting data indicative of the lighting condition within the target environment is determined by the processor module to be indicative of the predefined lighting condition data by reference to a predefined threshold criteria.

25. A device as claimed in claim 24 wherein the data store module is configured for storing a computer program that is operable by the processor module to configure the device for operation in accordance with claim 24.

26. A device as claimed in any one of claims 24 or 25 including a touch-sensitive electronic display module configured for operating as at least one of the output module and the input module.

27. A method for controlling operation of a lighting unit having a communication module and an illumination module for producing an output lighting emission within a target environment, the method including steps of:
(i) providing a data store module for storing at least one predefined lighting condition data indicative of a predefined lighting condition; and
(ii) providing a mobile electronic device comprising:
a communication module for communicating with the communication module of the lighting unit via a communication link;
a sensor module for sensing lighting data indicative of a lighting condition within the target environment;
a processor module configured for comparing the sensed data indicative of the lighting condition within the target environment against the at least one predefined lighting condition data indicative of the predefined lighting condition; and
a controller module, whereby, responsive to the comparison, the controller module is configured for communicating with the lighting unit via the communication link to controllably adjust the output lighting emission of the illumination module within the target environment until, based on further comparison by the processor module, the sensed lighting data indicative of the lighting condition within the target environment is determined by the processor module to be indicative of the predefined lighting condition data by reference to a predefined threshold criteria.

28. A method as claimed in claim 27 wherein the mobile electronic device includes at least one of a smartphone, a tablet and a portable computer.

29. A method as claimed in any one of claims 27 or 28 including a further processor module configured for partially or entirely comparing the data indicative of the sensed lighting condition within the environment against the at least one predefined lighting condition data, said further processor module including at least one of a processor module of the lighting unit, a server-side processor module and a cloud-based processor module communicably connected with the mobile electronic device.

30. A method as claimed in any one of claims 27 to 29 including a further controller module configured for partially or entirely controllably adjusting the output lighting emission of the illumination module within the target environment until, based on the further comparison by the processor module, the sensed lighting condition within the target environment is determined by the processor module or a further processor module to be indicative of the predefined lighting condition by reference to the predefined threshold criteria, said further processor module including at least one of a controller module of the lighting unit, a server-side controller module and a cloud-based controller module communicably connected with the mobile electronic device.

31. A method as claimed in any one of claims 27 to 30 wherein the data store module includes at least one of a data store module of the mobile electronic device, a data store module of the lighting unit, a server-side data store module and a cloud-based data store module communicably connected with the mobile electronic device.

32. A method as claimed in any one of claims 27 to 31 wherein the sensor module includes at least one of a CMOS-type sensor, a CCD-type sensor, a LiveMOS type sensor, an ambient light sensor, a photoelectric sensor, a thermal sensor, a temperature sensor, a gyroscope, a magnetometer, proximity sensor, and a GPS sensor.

33. A method as claimed in any one of claims 27 to 32 wherein the communication module of the lighting unit includes a wireless protocol communication module.

34. A method as claimed in any one of claims 27 to 33 wherein the predefined lighting condition data indicative of the predefined lighting condition includes data indicative of at least one of a brightness condition, a colour temperature condition, a dimming condition, a white light condition, and a warm light condition, a colour rendition index condition, and a saturation condition.

35. A method as claimed in any one of claims 27 to 34 wherein the data store module is configured for storing a plurality of predefined lighting condition datas each being indicative of one of a plurality of corresponding predefined lighting conditions.

36. A method as claimed in claim 35 wherein each of said plurality of predefined lighting conditions are associated with one of a plurality of corresponding target environment types.

37. A method as claimed in any one of claims 27 to 35 wherein the mobile electronic device includes:
an output module configured for electronically displaying indicia indicative of the plurality of target environment types; and
an input module configured for receiving as an input, a selection associated with an indicia indicative of one of the plurality of target environment types, whereby responsive to the selection, the processor module is configured for comparing the sensed data indicative of the lighting condition within the target environment against the predefined lighting condition data indicative of the predefined lighting condition associated with the corresponding target environment type selected via the input module, and, whereby, responsive to the comparison, the controller module is configured for communicating with the lighting unit via the communication link to controllably adjust the output lighting emission of the illumination module within the target environment until, based on further comparison by the processor module, the sensed lighting data indicative of the lighting condition within the target environment is determined by the processor module to be indicative of the predefined lighting condition data by reference to a predefined threshold criteria.

38. A method as claimed in claim 36 wherein the data store module is configured for storing a computer program that is operable by the processor module to configure the mobile electronic device for operation in accordance with claim 36.

39. A method as claimed in any one of claims 36 or 37 including a touch-sensitive electronic display module configured for operating as at least one of the output module and the input module.
